(19) United States
(12) Patent Application Publication
(10) Pub. No.: US 2009/0053504 A1
(43) Pub. Date: Feb. 26, 2009

(54) Method for Production of Carbon Composite Materials by Means of Plasma Pyrolysis and Thermal Spraying

(76) Inventors: Wolfgang Tillmann, Mohnesee (DE); Evelina Vogli, Dortmund (DE)

Correspondence Address: COLLARD & ROE, P.C., 1077 NORTHERN BOULEVARD, ROSLYN, NY, 11576, US

(21) Appl. No.: 11/991,719

(22) PCT Filed: Aug. 25, 2006
(86) PCT No.: PCT/DE2006/001519

§ 371 Date: Apr. 8, 2008

(30) Foreign Application Priority Data
Sep. 7, 2005 (DE) 10 2005 042 950.5

(51) Int. Cl. B32B 3/26; C23C 4/04; B05C 1/00

(52) U.S. Cl. 428/304.4; 427/450; 118/47

(57) ABSTRACT

The invention describes a method for producing carbon composite materials by pyrolysis and thermal spraying, in which method a material obtained at least partly from renewable raw materials is transformed by means of pyrolysis into a porously lattice-like matrix and this matrix is subsequently filled at least partially with an infiltration material by means of thermal spraying methods. Here, the pyrolysis of the material by means of a thermal spraying method is carried out until the porously lattice-like matrix of the carbonized material has formed, at least in certain regions, and subsequently at least the carbonized regions with the porously lattice-like matrix are coated with an infiltration material, or are at least partially filled by an infiltration material, likewise by means of thermal spraying methods.

The invention relates to a method for the production of carbon composite materials by means of plasma pyrolysis, in accordance with the preamble of claim 1.

The production of carbon composite materials is increasingly making a transition toward the use of biogenically renewable raw materials as a base material, to serve as carriers for metal or ceramic materials to be embedded in them. In this connection, the path is often taken of using biogenic base materials, such as wood, for the production of a porous lattice that is then at least partially filled with the materials to be embedded, usually by means of diffusion or similar processes, in place of the artificially created structures of filaments or woven textiles containing carbon, or the like, which were usual for a long time. In order to convert biogenic materials into such a structure of a porous lattice, the method of pyrolysis is usually used, in which the biogenic material is carbonized over a long period of time and with the exclusion of oxygen, by means of a vacuum or under a protective gas atmosphere, and, with corresponding shrinkage, the carbonized carbon structures form the porous lattice, disposed as in the case of wood cells, for example. By means of corresponding infiltration using various methods, this lattice is then filled, entirely or in certain regions, with the second component of the composite material, and thus a composite material is obtained that combines the advantageous properties of the carbon structures, which are solid after carbonization, with the properties of the infiltration material. Such materials are used, for example, for components subject to great mechanical stress. The complex and long treatment of the biogenic materials is a particular disadvantage in connection with the pyrolysis, but also in connection with the infiltration, thereby reducing the economic efficiency of the methods. Up to now, for these economic reasons, such composite materials have therefore not been used to the extent that is actually possible and desirable on the basis of the material properties.

It is known from U.S. Pat. No. 5,707,752 to spray a ceramic layer onto a wood material, which layer is applied by means of a plasma spraying method. However, in this connection, only a purely superficial coating is proposed, which does not yield any significant penetration depth into the wood. Also, the wood is not pyrolyzed, but rather only surface-activated, since the work is carried out under normal ambient atmosphere and the wood is merely combusted superficially, without pyrolysis.

The production of molded bodies on the basis of wood materials or other starting materials that contain carbon is known from DE 198 23 507 A1; these starting materials are infiltrated with silicon compounds and form corresponding composite materials in this connection. In this connection, carbonization of the molded body formed from wood, for example, takes place by way of carbonization methods that take a long time, at relatively low temperatures and under protective gas atmosphere or in a vacuum.

A metallization method is known from DE 103 37 456 A1, in which wood materials, among others, can also be metallized by means of plasma methods, whereby the plasma methods serve to activate the surface and therefore to improve the adhesion behavior of the coating on the base material. The production of composite materials having relevant penetration depths is not described.

A method for the production of a bone implant is known from DE 101 43 874 A1, in which a composite material is formed from a material at least partially obtained from renewable raw materials, including wood, for example, by means of pyrolysis and infiltration, whereby the infiltration can also be carried out by means of thermal spraying methods. The pyrolysis itself, however, takes place in a separate method step, by means of carbonization of a preformed body over a long period of time, over 6 to 20 hours, under an inert gas atmosphere, or also in a partial vacuum. As a result, the economic efficiency of the method and the process management during carbonization are problematical.

It is therefore the task of the present invention to further develop a method for the production of carbon composite materials by means of pyrolysis, in such a way that in particular, the pyrolysis can be carried out more simply and economically, and thus the production of the carbon composite material can be simplified.

The solution for the task according to the invention results from the characterizing features of claim 1, in interaction with the characteristics of the preamble. Other advantageous embodiments of the invention result from the dependent claims.

The invention proceeds from a method for the production of carbon composite materials by means of pyrolysis and thermal spraying, in which a material obtained at least partially from renewable raw materials is converted into a porous lattice-like matrix by means of pyrolysis, and this matrix is subsequently filled at least partially with an infiltration material, by means of thermal spraying methods. A method of this type is developed further, in a manner according to the invention, in that the pyrolysis of the material is carried out by means of a thermal spraying method, for such time until the porous lattice-like matrix of the carbonized material has formed, at least in certain regions, and subsequently, at least the carbonized regions having the porous lattice-like matrix are coated with an infiltration material, or at least partially filled by an infiltration material, also by means of thermal spraying methods. The possibility of carrying out both the pyrolysis and the infiltration using the same method, namely a thermal spraying method, particularly also in a close time sequence and, if applicable, on the same system, allows very efficient production of corresponding carbon composite materials, which furthermore are accelerated as compared with previously known methods, because of the short times needed to carry out the pyrolysis by means of the high-energy thermal spraying methods. In this way, very efficient production is made possible, with the quality at least remaining the same, but actually tending to increase, as compared with usual methods for pyrolysis, thereby making significantly broader fields of application of carbon composite materials produced in such a manner possible. Furthermore, very simple and very precise control of the regions of the material that are actually supposed to be pyrolyzed can be carried out during pyrolysis, by means of the energy applied very precisely at certain points on the basis of the thermal spraying methods. In this way, it is also possible to produce composite materials that are only partially pyrolyzed and thereby only infiltrated in these regions, with their properties being changed.

The various possible thermal spraying methods, particularly plasma spraying, arc spraying, or also flame spraying can be used. Of course, all other possible thermal spraying methods can be used in the present method, such as laser spraying or dynamic cold gas spraying.

With regard to the porous lattice-like matrix that forms from the material, it is particularly advantageous if the pyrolysis is carried out by means of a thermal spraying method under reduced pressure, particularly in a vacuum. At a reduced pressure or in a vacuum, the organic structures of the material cannot burn, and therefore form the porous lattice-like matrix that is needed for infiltration with the infiltration material, after carbonization.

In another possible embodiment, the pyrolysis can be carried out by means of a thermal spraying method under a protective gas atmosphere. The use of gases, for example argon, as a protective gas, also makes it possible to form the porous lattice-like matrix of the pyrolyzed material free of the harmful influence of oxygen, to a great extent, thereby maintaining the structure of the biogenic starting material. In a possible embodiment, a funnel-like shield can be used around the material to be pyrolyzed, which surrounds the material to be pyrolyzed, to a great extent, and into which protective gas is blown. By means of using such a funnel-like shield, it can be ensured that during point-by-point pyrolysis by means of the thermal spraying method, the funnel-like shield is moved, with the burner for the thermal spraying method, over the material to be pyrolyzed, and thus the pyrolyzed region of the material, in each instance, is locally reliably shielded from oxygen influence by means of the protective gas, without the amount of protective gas or the volume to be filled with the protective gas becoming too great. Of course, it is also possible that the material to be pyrolyzed is completely surrounded by a housing, in order to establish a protective gas atmosphere, and that protective gas is blown into the surrounding housing.

A particularly reliable and fast pyrolysis of biogenic materials can be carried out if the minimum temperature that the thermal spraying method introduces into the material to be pyrolyzed during pyrolysis is at least 400° C. At 400° C. or higher temperatures, the pyrolysis proceeds very rapidly, and can be applied very well to specific points onto the starting material, and controlled very well, by means of the high-energy thermal spraying methods.

A further improvement of the method can be achieved if the coating and/or infiltration of the infiltration material is carried out by means of thermal spraying methods, at normal ambient atmosphere, in other words if the usual method of procedure of the thermal spraying methods is used.

It is particularly advantageous for the structure of the composite material if materials having a high melting point, particularly metallic materials or ceramic materials, for example, are used as the infiltration material. Such materials having a high melting point form very high-strength bonds with the matrix of the pyrolyzed material, and furthermore can generally withstand very great stress, mechanically and thermally, because of the properties of the materials having a high melting point, for example if they are used in construction components. Also, depending on the infiltration materials used, a targeted influence on the degree of infiltration can be achieved, since ceramic materials, for example, as materials in powder form, have lower degrees of infiltration than metallic materials that are infiltrated in liquid form, which can penetrate deeper into the matrix because of the additional capillary effect of the porous matrix.

Another improvement of the method can be achieved if the material obtained at least partially from renewable raw materials is pyrolyzed in such a shape and in such dimensions, as a molded body, that after pyrolysis, the molded body essentially has the dimensions and the shape of the composite component to be produced. In this connection, it will be possible to work very close to final dimensions, taking into consideration the unavoidable shrinkage process of the material, which is at least partially obtained from renewable raw materials, so that subsequent processing of the material, after production of the composite material, can be reduced to a minimum.

It is advantageous with regard to the strength and the properties of the composite material if after pyrolysis, the material obtained at least partially from renewable raw materials has an open-pore matrix of carbon, pre-determined by the original microcellular structure of the material. Such microcellular structures usually have very high strength values, which can be further increased in that after pyrolysis, the matrix is formed from carbon, which itself, in turn, can have high strength values. As a particularly advantageous starting material, wood can be used as a material that is at least partially obtained from renewable raw materials, whereby a restriction to wood alone is not necessary, of course. Instead, for one thing, different kinds of wood having different structures and also different mechanical properties, furthermore also any other biogenic materials having corresponding structures can be used as the starting material for pyrolysis and infiltration. Advantage can also be taken of the fact that the strength of the porous matrix after pyrolysis can be utilized and controlled by means of the structure of different types of wood, for example, in each instance. Furthermore, the ability of the matrix to be infiltrated after pyrolysis can also be influenced by means of the selection of the biogenic material on the basis of its structure before pyrolysis, since the structure before pyrolysis determines the geometric configuration and thus the porosity and capillarity of the carbonized matrix, to a great extent.

It is advantageous with regard to process management if the burner for carrying out the thermal spraying method is guided along tracks relative to the material to be pyrolyzed, which tracks can be predetermined. The pyrolysis of the material can be locally controlled with great accuracy by means of the position and assignment of the individual tracks, as well as the corresponding overlaps of the individual tracks, so that the degree of pyrolysis and thus also the formation of the porously formed matrix can be controlled within broad limits. In this connection, both the penetration depth and the degree of effectiveness of the pyrolysis can be adapted to the need for deformation of the starting material, in each instance. In this connection, of course, it can also be assured, in another embodiment, that the tracks are configured in three dimensions, in order to influence the spatial arrangement of the pyrolyzed regions on the outer surfaces and within the material. The pyrolysis can be structured in particularly simple and reproducible manner in that the burner for carrying out the thermal spraying method is guided by an industrial robot or a handling device, in one plane or three dimensions.

Another advantage of the method according to the invention consists in the fact that the pyrolyzed material is subjected to thermal treatment, after infiltration with the infiltration material, in such a manner that the penetration depth and/or the bonding of the infiltration material to the pyrolyzed material are influenced. By means of corresponding thermal treatment, a further change in the degree of infiltration or the infiltration depth of the infiltration material into the porous matrix of the composite material can be brought about even after the actual completion of infiltration under the influence of the thermal spraying method. In this connection, it is also possible that the structural states of the infiltration material in the composite structure are influenced by means of the thermal treatment.

The invention furthermore relates to a device for the production of carbon composite materials by means of pyrolysis and thermal spraying, which has a mechanism for carrying out a thermal spraying method for the production of carbon composite materials by means of pyrolysis and thermal spraying, according to one of the preceding claims.

Furthermore, the invention proposes a carbon composite material and a component produced from it, produced by means of pyrolysis and thermal spraying, according to one of claims 1 to 27. Such components can be rather thin-walled components, for one thing, which can be pyrolyzed and infiltrated completely, i.e. over their entire cross-section, but it is also possible to pyrolyze components having a thicker wall close to the surface, and to infiltrate them only in these regions.

Such components and composite materials, produced according to the invention, are used for applications in electrical technology, in which such components must demonstrate increased mechanical strength properties. Also, it is possible to secure wood components against thermal influences such as fire in this way, and also, components that are configured as foam structures nowadays, in many cases, for example in the motor vehicle industry, can be replaced. Other than that, of course, all areas of use that are usual and widespread for composite materials are also possible. Examples of use of components produced according to the invention can be the automotive industry (e.g. brake disks, clutch disks), the aeronautics industry (e.g. structural components), the space industry (e.g. satellite antennas), or also the sports articles industry (e.g. skis or snowboards).

1. Method for the production of carbon composite materials by means of pyrolysis and thermal spraying, in which a material obtained at least partially from renewable raw materials is converted into a porous lattice-like matrix by means of pyrolysis, and this matrix is subsequently filled at least partially with an infiltration material, by means of thermal spraying methods, wherein the pyrolysis of the material is carried out by means of a thermal spraying method, for such time until the porous lattice-like matrix of the carbonized material has formed, at least in certain regions, and subsequently, at least the carbonized regions having the porous lattice-like matrix are coated with an infiltration material, or at least partially filled by an infiltration material, also by means of thermal spraying methods.

2. Method according to claim 1, wherein the thermal spraying method brings about the pyrolysis of the material within a short period of time.

3. Method according to claim 1, wherein a plasma spraying process is used as the thermal spraying method.

4. Method according to claim 1, wherein an arc spraying process is used as the thermal spraying method.

5. Method according to claim 1, wherein a flame spraying process is used as the thermal spraying method.

6. Method according to claim 1, wherein the pyrolysis is carried out by means of a thermal spraying method, under reduced pressure.

7. Method according to claim 6, wherein the pyrolysis is carried out by means of a thermal spraying method, in a vacuum.

8. Method according to claim 1, wherein the pyrolysis is carried out by means of a thermal spraying method, under a protective gas atmosphere.

9. Method according to claim 8, wherein argon is used as the protective gas.

10. Method according to claim 8, wherein a funnel-like shield is used around the material to be pyrolyzed, to establish a protective gas atmosphere, which shield surrounds the material to be pyrolyzed, to a great extent, and into which shield protective gas is blown.

11. Method according to claim 10, wherein the funnel-like shield is moved relative to the material to be pyrolyzed, together with the burner for the thermal spraying method.

12. Method according to claim 8, wherein the material to be pyrolyzed is surrounded by a housing in order to establish a protective gas atmosphere, and that protective gas is blown into the housing.

13. Method according to claim 1, wherein the minimum temperature that the thermal spraying method exerts on the material to be pyrolyzed during pyrolysis is at least 400 C.

14. Method according to claim 1, wherein the coating and/or the infiltration of the infiltration material are carried out by means of thermal spraying method, at normal ambient atmosphere.

15. Method according to claim 1, wherein the pyrolysis and the coating and/or the infiltration are carried out on the same system for the thermal spraying method.

16. Method according to claim 1, wherein the pyrolysis and the coating and/or the infiltration are carried out directly one after the other, in terms of time.

17. Method according to claim 1, wherein materials having a high melting point are used as the infiltration material.

18. Method according to claim 1, wherein metallic materials are used as the infiltration material.

19. Method according to claim 1, wherein ceramic materials are used as the infiltration material.

20. Method according to claim 1, wherein material at least partially obtained from renewable raw materials is pyrolyzed in such a shape and in such dimensions, as a molded body, that after pyrolysis, the molded body essentially has the dimensions and the shape of the composite component to be produced.

21. Method according to claim 1, wherein after pyrolysis, the material obtained at least partially from renewable raw materials has an open-pore matrix of carbon, pre-determined by the original microcellular structure of the material.

22. Method according to claim 1, wherein wood is used as the material obtained at least partially from renewable raw materials.

23. Method according to claim 1, wherein the burner for carrying out the thermal spraying method is guided along tracks relative to the material to be pyrolyzed, which tracks can be predetermined.

24. Method according to claim 23, wherein the tracks are configured in three dimensions, in order to influence the spatial arrangement of the pyrolyzed regions within the material.

25. Method according to claim 23, wherein the burner for carrying out the thermal spraying method is guided by an industrial robot or a handling device, in one plane or three dimensions.

26. Method according to claim 1, wherein the pyrolyzed material is subjected to a thermal treatment after infiltration with the infiltration material.

27. Method according to claim 26, wherein the pyrolyzed material is subjected to thermal treatment, after infiltration with the infiltration material, in such a manner that the penetration depth and/or the bonding of the infiltration material to the pyrolyzed material are influenced.

28. Method according to claim 26, wherein the pyrolyzed material is subjected to thermal treatment, after infiltration with the infiltration material, in such a manner that the structural states of the infiltration material in the composite structure are influenced.

29. Device for the production of carbon composite materials by means of pyrolysis and thermal spraying, wherein the device has a mechanism for carrying out a thermal spraying method for the production of carbon composite materials by means of pyrolysis and thermal spraying, according to claim 1.

30. Carbon composite material and component produced from it, produced by means of pyrolysis and thermal spraying according to claim 1.
